(19) United States
(12) Patent Application Publication
(10) Pub. No.: US 2025/0334207 A1
(43) Pub. Date: Oct. 30, 2025

(54) FASTENING SYSTEM FOR FASTENING AN OBJECT TO A SUPPORT AND AIRCRAFT COMPRISING AT LEAST ONE SUCH SYSTEM

(71) Applicant: Airbus Operations SAS, TOULOUSE (FR)

(72) Inventors: Xavier KERN, TOULOUSE (FR); Benjamin THUBERT, TOULOUSE (FR)

(21) Appl. No.: 19/185,814

(22) Filed: Apr. 22, 2025

(30) Foreign Application Priority Data
Apr. 26, 2024 (FR) FR2404362

(51) Int. Cl. F16L 3/10

(52) U.S. Cl. CPC F16L 3/1091

(57) ABSTRACT

A fastening system for fastening an object to a support, comprising a first fastening element and a second fastening element placed on either side of the support, and fasteners for fastening the object, the fasteners fastened to one of the fastening elements. The fastening system comprises an element, such as an elastic element, which is integrally fixed to the fastening elements and/or a lock integrally fixed to the fastening elements. Also an aircraft with such a fastening system.

### CROSS-REFERENCES TO RELATED APPLICATIONS

This application claims the benefit of French Patent Application Number FR 2404362 filed on Apr. 26, 2024, the entire disclosure of which is incorporated herein by way of reference.

### FIELD OF THE INVENTION

The present invention relates to a fastening system enabling an object to be fastened to a support. The invention relates, in particular, to the fastening of an object which is present in the form of one or more cables or conduits in an aircraft.

### BACKGROUND OF THE INVENTION

In an aircraft, it often arises that the cables or conduits have to be fastened to supports which can take the form of a bar or an upright, for example. These cables or conduits can also be fastened to one another in order to hold them together before being fastened to the support.

Currently, in order to ensure the fastening of the cables to a support it is known, in particular, to use fastening systems comprising a first and a second fastening element clamping the support, one of the elements being provided with fastening means for fastening the cable to the fastening element. In order to fasten the fastening elements to the support, it is known to screw or rivet each fastening element to the support. A further solution aims to pass a clamping ring through the two fastening elements and to clamp this clamping ring in order to retain the fastening elements in position on the support.

A drawback with this solution is that the use of screws, rivets or clamping collars creates a risk of the system being incorrectly fastened to the support. More specifically, there is a risk that one of the two fastening elements is not fastened, or is incorrectly fastened, to the support during the fastening operation.

Moreover, these solutions involve a risk of debris from foreign objects being present in the aircraft after the assembly has been completed. More specifically, the screws, rivets or clamping collars can easily drop down and thus be forgotten or mislaid by the operator during the fastening operations, which can then lead to damage during the use of the aircraft.

Finally, since the working area inside the aircraft is sometimes confined, the fastening of the system to the support using these solutions can prove to be relatively difficult since it requires a greater dexterity from the operator when two hands of the operator are generally required for carrying out this fastening operation.

It is thus necessary to find a solution which is simple and rapid to implement and which enables a reliable fastening of an object to a support to be ensured.

### SUMMARY OF THE INVENTION

One subject of the present invention is to propose a fastening system which enables an object to be fastened to a support in a simple and rapid manner.

To this end, a fastening system for fastening an object is proposed, in which the system comprises a first fastening element and a second fastening element which are designed to be placed on either side of said support and to clamp said support. The system further comprises fastening means for fastening the object, said fastening means being fastened to one of said first or second fastening elements. More specifically, each fastening element comprises:
a base;
a retaining tab extending from said base, said retaining tab defining with said base a receiving space in which said support is designed to be received;
a guide channel passing through said base in a direction of introduction;
a guide bar extending parallel to said direction of introduction from said base, said guide bar having a first end which is fastened to said base and a second free end which is received in said guide channel of the other fastening element when said first and second fastening elements are assembled.

According to the invention, said fastening system further comprises approaching means which are integrally fixed to at least one of the first and second fastening elements and which are arranged so as to clamp said first and second fastening elements to one another by clamping said support and/or locking means which are integrally fixed to at least one of the first and second fastening elements and which are arranged so as to lock the position of said first and second fastening elements relative to one another.

The system of the invention enables an object to be fastened to a support in a simple and rapid manner. The system of the invention can be automatically adjusted to the width of the support due to the approaching means and/or easily locked in position due to the locking means which are already mounted/fastened onto the system. The use of the system can thus be implemented with one hand, which facilitates the fastening of objects to supports in confined spaces. In addition, since the system already comprises approaching means and/or locking means which are fastened to the first and/or second fastening elements, the risk of incorrect fastening is eliminated, in addition to that of losing a screw, a rivet or a clamping collar, for example.

Advantageously, said approaching means comprise an elastic element connecting said first and second fastening elements.

According to one embodiment, said elastic element is a tension spring, where a first end of said spring is fastened to said base of said first fastening element and where a second end of said spring is fastened to said base of said second fastening element. According to a second embodiment, each of said bases comprises two openings which are generally parallel and pass through said base parallel to the direction of introduction, said openings being separated by a wall, where said elastic element is an elastic band passing into said openings of said first and second fastening elements and clamping said walls of each fastening element so as to pull the fastening elements toward one another.

According to one particular aspect, said locking means comprise a first locking assembly comprising a first flexible link which is fastened in the region of a proximal end of said first link to said base of said first fastening element and a first cage which is fastened to said base of said second fastening element, where said first cage has a first tunnel in order to receive a distal end of the first link, and where said first cage is provided with a blocking system permitting the displacement of said first link in the first tunnel in a single clamping direction.

According to a further particular aspect, said locking means comprise a second locking assembly comprising a second flexible link which is fastened in the region of a proximal end of the second link to said base of said second fastening element and a second cage which is fastened to said base of said first fastening element, where said second cage has a second tunnel in order to receive a distal end of the second link, and where said second cage is provided with a blocking system permitting the displacement of the second link in the second tunnel in a single clamping direction.

According to a further particular aspect, said blocking systems each comprise an unlocking lever permitting the displacement of the link in the tunnel in an unclamping direction opposing said clamping direction.

The invention further relates to an aircraft comprising an object to be fastened to a support and a fastening system, as described above, which is arranged to fasten said object to said support.

### BRIEF DESCRIPTION OF THE DRAWINGS

The above-mentioned features of the invention, in addition to others, will become clearer by reading the following description of several embodiments, said description being made in relation to the accompanying drawings, in which;

FIG. 1 illustrates a perspective view of a fastening system according to an embodiment according to the invention, the fastening system comprising locking means;

FIG. 2 illustrates a perspective view of a fastening system according to a further embodiment according to the invention, the fastening system comprising a first example of approaching means;

FIG. 3 illustrates a perspective view of a fastening system according to yet another embodiment according to the invention;

FIG. 4 illustrates a perspective view of a variant of the fastening system of FIG. 3; and

FIG. 5 illustrates an aircraft comprising a plurality of fastening systems according to the invention.

### DETAILED DESCRIPTION OF THE PREFERRED EMBODIMENTS

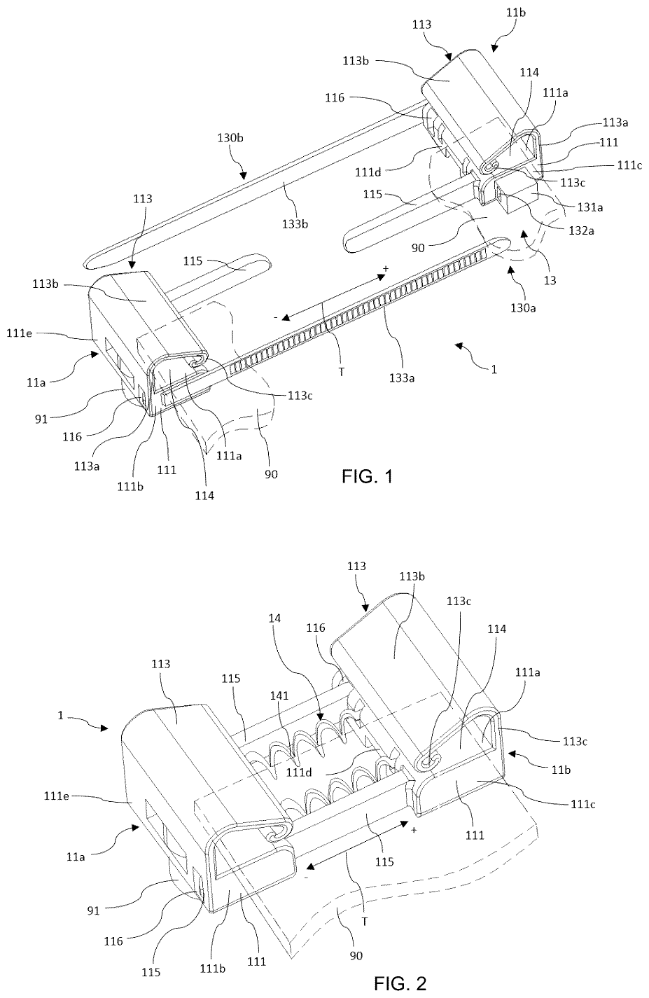

FIGS. 1 to 4 show examples of the fastening system 1 according to the invention, which are called hereinafter the “system”. The system 1 enables an object to be fastened to a support 90. For reasons of clarity, the support 90 is partially illustrated and is shown in dashed lines in FIGS. 1 and 2. The support 90 is not illustrated in the following figures. The object can take many forms and can consist, for example, of one or more cables or conduits, or any other object to be fastened. The support 90 can also take many forms and can be, for example, in the form of a bar or an upright forming a rail to which the fastening system 1 of invention is fastened.

The system 1 enables the object to be fastened to the support 90 and it comprises a first fastening element 11a and a second fastening element 11b. The first 11a and second 11b fastening elements are placed on either side of the support 90 and clamp this support.

The system 1 also comprises fastening means 91 which ensure the fastening of the object to the system 1 and thus to the support 90. The fastening means 91 are fastened to one of the first 11a or second 11b fastening elements. In this example, the fastening means 91 are shown schematically and are fastened to the first fastening element 11a. The fastening means 91 can take many forms such as a screw or rivet and can be arranged differently on the first 11a fastening element and/or on the second 11b fastening element.

Each fastening element 11a, 11b comprises a base 111 which in this example is generally parallelepipedal and a retaining tab 113 which extends from the base 111. The retaining tab 113 defines with the base 111 a receiving space 114 in which the support 90 is designed to be received and potentially enables the guidance of the first 11a and second 11b fastening elements in the case where the first 11a and second 11b fastening elements are displaced by sliding along the support 90 before being locked. The retaining tab 113 has a substantially recumbent L-shape and generally extends over the entire length of the base 111. More specifically, the base 113a of the L-shape generally extends perpendicularly to an upper surface 111a of the base 111, while the upright 113b of the L-shape generally extends parallel, and thus generally opposite, the upper surface 111a of the base 111 in order to form together with the base 111 the receiving space 114 of the support 90. In this example, the receiving space generally has a U-shape. A curved portion 113c can extend, as illustrated here, from the free end of the upright 113b in the direction of the upper surface 111a of the base 111 in order to optimize the retention of the support 90 in the receiving space 114.

Each fastening element 11a, 11b further comprises, on a front face 111d of the base 111, a guide channel 116 passing through the base in a direction of introduction T. The direction of introduction T generally extends perpendicularly to the longitudinal axis of the base 111 and parallel to the upper surface 111a of the base 111.

Each fastening element 11a, 11b also comprises a guide bar 115 which extends parallel to the direction of introduction T from the base 111. The guide bar 115 thus protrudes from the base 111 (and more particularly from a front face 111d) and has a first end fastened to the base 111 and a second free end received in the guide channel 116 of the other fastening element 11b, 11a when the first and second fastening elements 11a, 11b are assembled.

In other words, each fastening element 11a, 11b has a guide bar 115 and a guide channel 116. The guide bar 115 of each fastening element 11a, 11b penetrates into the guide channel 116 of the other fastening element 11a, 11b. According to the invention, the fastening system 1 also comprises approaching means 14 which are integrally fixed to at least one of the first 11a and second 11b fastening elements and arranged so as to clamp the first 11a and second 11b fastening elements to one another parallel to the direction of introduction T by clamping the support 90 and/or locking means 13 which are integrally fixed to at least one of the first 11a and second 11b fastening elements and arranged so as to lock the position of the first 11a and second 11b fastening elements relative to one another, in particular when the first 11a and second 11b fastening elements clamp the support 90 between one another.

When the term “integrally fixed” is used to specify that the locking means 13 and/or the approaching means 14 are integrally fixed to at least one of the first 11a and second 11b fastening elements, this signifies that these means are fastened to at least one of the first 11a and second 11b fastening elements. In other words, the means 13, 14 cannot be separated from the fastening elements 11a, 11b. The means are formed, for example, in one piece with the locking means 13.

In this manner, it is made possible to fasten an object to a support in a simple and rapid manner. The system 1 of the invention can be automatically adjusted to the width of the support 90 due to the approaching means 14 and/or easily locked in position due to the locking means 13 which are already mounted/fastened onto the system 1. The use of the system 1 of the invention can thus be implemented with one hand, which facilitates the fastening of objects to supports in confined spaces.

In addition, since the system 1 already comprises approaching means 14 and/or locking means 13 which are fastened to the first 11a and second 11b fastening elements, the risk of incorrect fastening is eliminated, in addition to that of losing a screw, a rivet or a clamping collar, for example.

Moreover, the first 11a and second 11b fastening elements are substantially identical which facilitates their manufacture and their use.

FIG. 1 shows a system 1 solely comprising locking means 13 locking the position of the first 11a and second 11b fastening elements relative to one another. FIG. 2 shows a system 1 solely comprising approaching means 14 (in a first embodiment) which are arranged so as to clamp the first 11a and second 11b fastening elements to one another by clamping the support 90.

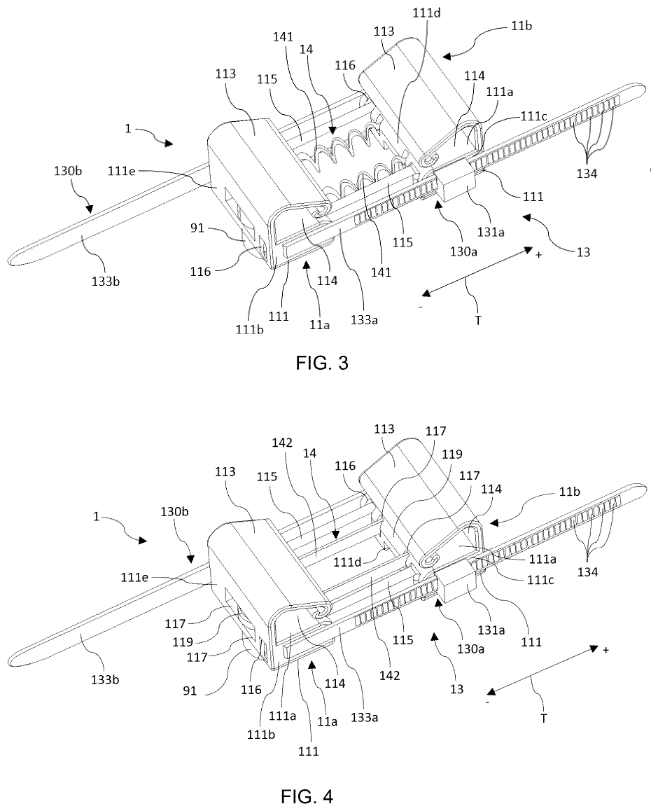

FIGS. 3 and 4 show a system 1 comprising locking means 13 and approaching means 14 (respectively according to the first embodiment and according to a second embodiment).

Preferably, the approaching means 14 comprise an elastic element connecting the first 11a and second 11b fastening elements to one another. The elastic element is tensioned in the clamped position so as to pull the first 11a and second 11b fastening elements toward one another and to enable the first 11a and second 11b fastening elements to be clamped around the support 90 without any action by the operator.

According to a first embodiment illustrated in FIGS. 2 and 3, the elastic element is a tension spring 141 where a first end of the spring 141 is fastened to the base 111 of the first fastening element 11a and where a second end of the spring 141 is fastened to the base 111 of the second fastening element 11b. More specifically, the tension spring 141 is capable of exerting tension between the fastening elements 11a, 11b in order to clamp the support 90. The spring 141 thus has a length which is adapted to the width of the support 90. Moreover, the pulling force exerted by the spring 141 is adapted so that the operator can position the fastening elements 11a and 11b on either side of the support 90 easily and without the use of tools.

In this manner, no adjustment of the spacing of the fastening elements 11a and 11b is required on the part of the operator since the approaching means 14 enable this operation to be carried out automatically. The positioning and use of the system 1 are thus simple.

According to a second embodiment illustrated in FIG. 4, each of the bases 111 comprises two generally (+/−10%) parallel openings 117. The openings 117 pass through the base 111 parallel to the direction of introduction T and are separated by a wall 119. More specifically, the openings 117 extend between the front face 111d and the rear face 111e of the base 111. In this case, the elastic element is an elastic band 142, for example made of rubber, which passes into said openings 117 of the first 11a and second 11b fastening elements, clamping the walls 119 of each fastening element 11a, 11b so as to pull the fastening elements 11a, 11b toward one another.

In this example, a single closed elastic band, forming a loop, passes through the openings 117 of the fastening elements 11a and 11b and surrounds the walls 119 of the two fastening elements 11a and 11b to pull them toward one another. The elastic band 142 is capable of exerting tension between the fastening elements 11a and 11b in order to clamp the support 90. The elastic band 142 thus has a length which is adapted to the width of the support 90. Moreover, the pulling force exerted by the elastic band 142 is adapted so that the operator can position the fastening elements 11a and 11b on either side of the support 90 easily and without the use of tools.

In this manner, no adjustment of the spacing of the fastening elements 11a and 11b is necessary on the part of the operator since the approaching means 14 enable this operation to be carried out automatically. The positioning and use of the system 1 are thus simple.

As illustrated in FIGS. 1, 3 and 4, the locking means 13 comprise a first locking assembly 130a comprising a first flexible link 133a which generally extends parallel to the direction of introduction T and which is fastened in the region of a proximal end of the first link 133a to the base 111 of the first fastening element 11a and more specifically in this case in the region of a first lateral face 111b of the base 111. The first locking assembly 130a also comprises a first cage which is fastened to the base 111 of the second fastening element 11b and more specifically in this case in the region of a second lateral face 111c of the base 111. The first cage 131a has a first tunnel 132a which generally extends parallel to the direction of introduction T and which is configured to receive a distal end of the first link 133a. The first cage 131a is provided with a blocking system permitting the displacement of the first link 133a in the first tunnel 132a in a single clamping direction “+” and preventing the displacement of the first link 133a in the first tunnel 132a in an unclamping direction “−” opposing the clamping direction.

In this manner, the system 1 enables a so-called automatic, and thus simple, locking of the position of the fastening elements 11a and 11b relative to one another. It is thus no longer necessary to use screws, rivets or clamping collars to lock the position of the fastening elements 11a and 11b. This eliminates the risks of debris from foreign objects being present in the aircraft after the assembly has been completed.

Preferably, the locking means 13 comprise a second locking assembly 130b which has an identical structure and operation. This second locking assembly 130b is arranged on the lateral faces opposing the lateral faces of the bases 111 carrying the first locking assembly 130a. More specifically the second locking assembly 130b comprises a second flexible link 133b which generally extends parallel to the direction of introduction T and which is fastened in the region of a proximal end of the second link 133b to the base 111 of the second fastening element 11b and more specifically in this case in the region of a second lateral face of the base 111. The second locking assembly 130b further comprises a second cage which is fastened to the base 111 of the first fastening element 11a in this case in the region of a first lateral face of the base 111. The second cage has a second tunnel extending parallel to the direction of introduction T to receive a distal end of the second link 133b. As above, the second cage 133b is provided with a blocking system permitting the displacement of the second link 133b in the second tunnel in the single clamping direction “+” and preventing the displacement of the second link 133b in the second tunnel in the unclamping direction “−”.

In this manner, the system 1 enables a so-called automatic, and thus simple, locking of the position of the fastening elements 11a and 11b relative to one another. It is thus no longer necessary to use screws, rivets or clamping collars to lock the position of the fastening elements 11a and 11b. This eliminates the risks of debris from foreign objects being present in the aircraft after the assembly has been completed.

The use of two locking assemblies 130a and 130b on either side of the bases 111 of the fastening elements 11a and 11b makes it possible to ensure a reliable and optimal locking of the position of the fastening elements 11a and 11b relative to one another. Moreover, the two locking assemblies 130a and 130b make it possible to ensure that the fastening elements 11a and 11b extend parallel to one another on each side of the support 90 so as to optimize the locking of the system 1.

Moreover, the use of two independent locking assemblies 130a and 130b makes it possible to ensure an optimal security of the fastening of the object to the support 90 since the fastening of the fastening system 1 to the support 90 is ensured, even if one of the two locking assemblies 130a and 130b has a defect.

For example, the blocking systems each comprise a ratchet system, which is housed in the tunnel, and teeth 134 produced on one of the faces of the flexible links 133a, 133b. The teeth 134 interact with the ratchet system to permit the displacement of the flexible links 133a, 133b in their respective tunnel in the clamping direction “+” and prevent the displacement of the flexible links 133a, 133b in the unclamping direction “−”.

Preferably, the blocking systems each comprise an unlocking lever enabling the flexible links 133a, 133b to be released in order to permit their displacement in the tunnels 132a in the unclamping direction. Thus the unlocking lever makes it possible to release the teeth of the ratchet system.

In this manner, it is possible to unlock the locking assemblies 130a and 130b so as to release the flexible links 133a and 133b and to enable their displacement in the direction opposing the clamping direction when it is necessary to unclamp, i.e., to separate, the fastening elements 11a and 11b from one another. Thus the system 1 is removable and thus reusable.

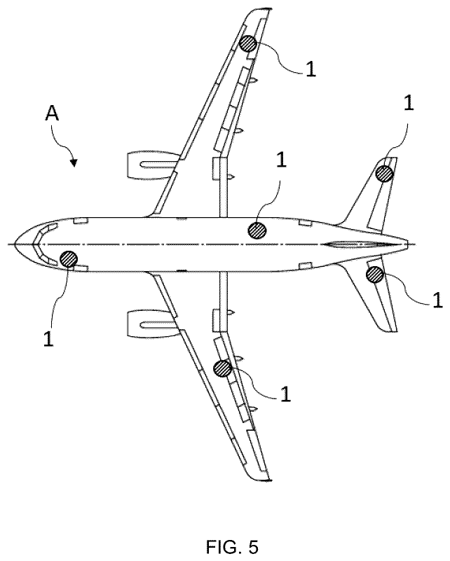

FIG. 5 shows an aircraft A comprising at least one fastening system 1 for fastening an object to a support 90. The use of such fastening systems 1 in an aircraft advantageously makes it possible to facilitate the assembly operations of electrical, electronic or fluidic systems, in particular in confined spaces, and thus to increase the efficiency.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fastening system for fastening an object to a support, said system comprising:
a first fastening element;
a second fastening element which is configured to be placed on either side of a support and to clamp said support; and,
fastening means for fastening an object, said fastening means being fastened to at least one of said first and second fastening elements,
wherein each fastening element comprises a base, a retaining tab extending from said base, said retaining tab defining with said base a receiving space in which said support is received, a guide channel passing through said base in a direction of introduction, a guide bar extending parallel to said direction of introduction from said base, said guide bar having a first end which is fastened to said base and a second free end which is received in said guide channel of the other fastening element when said first and second fastening elements are assembled, and
wherein the fastening system further comprises approaching means integrally fixed to at least one of the first and second fastening elements and which are arranged to clamp said first and second fastening elements to one another by clamping said support, or locking means integrally fixed to at least one of the first and second fastening elements and which are arranged so as to lock a position of said first and second fastening elements relative to one another, or by both.

2. The fastening system according to claim 1, wherein said approaching means comprise an elastic element connecting said first and second fastening elements.

3. The fastening system according to claim 2, wherein said elastic element is a tension spring, where a first end of said spring is fastened to said base of said first fastening element and where a second end of said spring is fastened to said base of said fastening element so as to pull the first and second fastening elements toward one another.

4. The fastening system according to claim 2, wherein each of said bases comprises two base openings which are generally parallel and pass through said base parallel to the direction of introduction, said openings being separated by a wall, and, wherein said elastic element is an elastic band passing into said base openings of said first and second fastening elements and clamping said walls of each fastening element so as to pull the first and second fastening elements toward one another.

5. The fastening system according to claim 1, wherein said locking means comprise a first locking assembly comprising a first flexible link which is fastened in a region of a proximal end of said first flexible link to said base of said first fastening element and a first cage which is fastened to said base of said second fastening element,
wherein said first cage has a first tunnel in order to receive a distal end of the first link, and
wherein said first cage is provided with a blocking system permitting a displacement of said first link in the first tunnel in a single clamping direction.

6. The fastening system according to claim 5, wherein said locking means further comprise a second locking assembly comprising a second flexible link which is fastened in a region of a proximal end of the second flexible link to said base of said second fastening element and a second cage which is fastened to said base of said first fastening element,
wherein said second cage has a second tunnel in order to receive a distal end of the second link, and
wherein said second cage is provided with a blocking system permitting a displacement of the second link in the second tunnel in a single clamping direction.

7. The fastening system according to claim 5, wherein said blocking systems each comprise an unlocking lever permitting a displacement of the respective flexible link in the respective tunnel in an unclamping direction opposing said clamping direction.

8. An aircraft comprising:
an object to be fastened to a support and
the fastening system according to claim 1 which fastens said object to said support.
